(19) United States
(12) Patent Application Publication
(10) Pub. No.: US 2025/0158864 A1
(43) Pub. Date: May 15, 2025

(54) CONFIGURATION OF NEIGHBORING RS RESOURCE

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 18/838,572

(22) PCT Filed: Apr. 28, 2022
(86) PCT No.: PCT/CN2022/089924

§ 371 Date: Aug. 14, 2024

(51) Int. Cl. H04L 27/26; H04B 7/06; H04B 17/318; H04W 24/10

(52) U.S. Cl. CPC H04L 27/261; H04B 7/0626; H04B 7/06964; H04B 17/328; H04W 24/10

(57) ABSTRACT

The UE may receive a neighboring RS resource configuration associated with an RS resource set and identify one or more neighboring RS resources associated with at least one target RS resource based on the neighboring RS resource configuration. The method of wireless communication may improve beam management through enabling the UE to report not just measurements of a strongest beam, but also enabling the UE to identify one or more neighboring beams associated with a target beam as a part of beam management, without increasing the signaling overhead to indicate the neighboring beams.

### TECHNICAL FIELD

The present disclosure relates generally to communication systems, and more particularly, to a method of wireless communication including configuration of neighboring reference signal (RS) resource.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE) and a network node. The UE may receive a neighboring RS resource configuration associated with an RS resource set and identify one or more neighboring RS resources associated with at least one target RS resource based on the neighboring RS resource configuration. The network node may output a neighboring RS resource configuration associated with an RS resource set, and obtain information for a UE based on at least one target RS resource and one or more neighboring RS resources associated with at least one target RS resource based on the neighboring RS resource configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A illustrates an example flow diagram of a beam management procedure for a base station and a UE, in accordance with various aspects of the present disclosure.

FIG. 4B illustrates an example of SSB beam sweeping between the base station and the UE, in accordance with various aspects of the present disclosure.

FIG. 4C illustrates an example of beam refinement between the base station and the UE, in accordance with various aspects of the present disclosure.

FIG. 5 is an example of artificial intelligence (AI)/machine learning (ML) (AI/ML) algorithm of a method of wireless communication.

FIGS. 6A and 6B are sets of reference signal (RS) resources of a method of wireless communication.

FIG. 7 is sets of RSs of a method of wireless communication.

FIG. 8 is a call-flow diagram of a method of wireless communication.

FIGS. 9A and 9B are flowcharts of a method of wireless communication.

FIG. 10 is a diagram illustrating an example of a hardware implementation.

FIG. 11 is a flowchart of a method of wireless communication.

FIG. 12 is a diagram illustrating an example of a hardware implementation.

### DETAILED DESCRIPTION

The method may improve beam management through enabling the UE to report not just measurements of a strongest beam, but also enabling the UE to identify one or more neighboring beams associated with a target beam as a part of beam management, without increasing the signaling overhead to indicate the neighboring beams.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (NB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

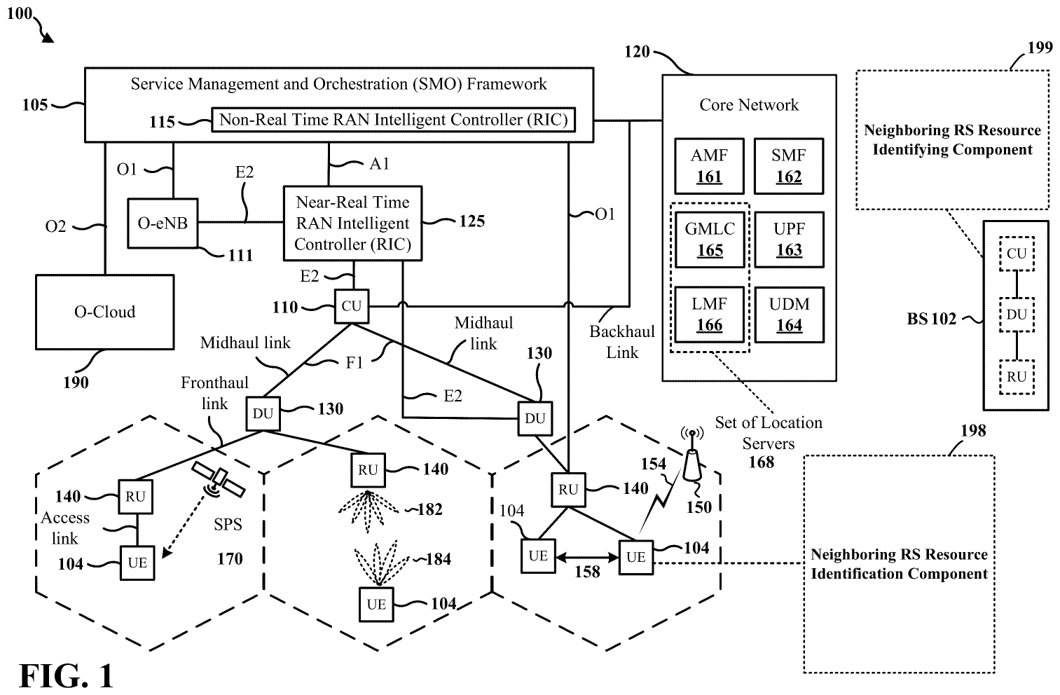

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a neighboring RS resource identification component 198 configured to receive a neighboring RS resource configuration associated with an RS resource set and identify one or more neighboring RS resources associated with at least one target RS resource based on the neighboring RS resource configuration. In certain aspects, the base station 102 may include a neighboring RS resource identifying component 199 configured to output a neighboring RS resource configuration associated with an RS resource set, and obtain information for a UE based on at least one target RS resource and one or more neighboring RS resources associated with at least one target RS resource based on the neighboring RS resource configuration. Although the following description may be focused on 5G NR, the concepts described herein may be applicable to other similar areas, such as LTE, LTE-A, CDMA, GSM, and other wireless technologies.

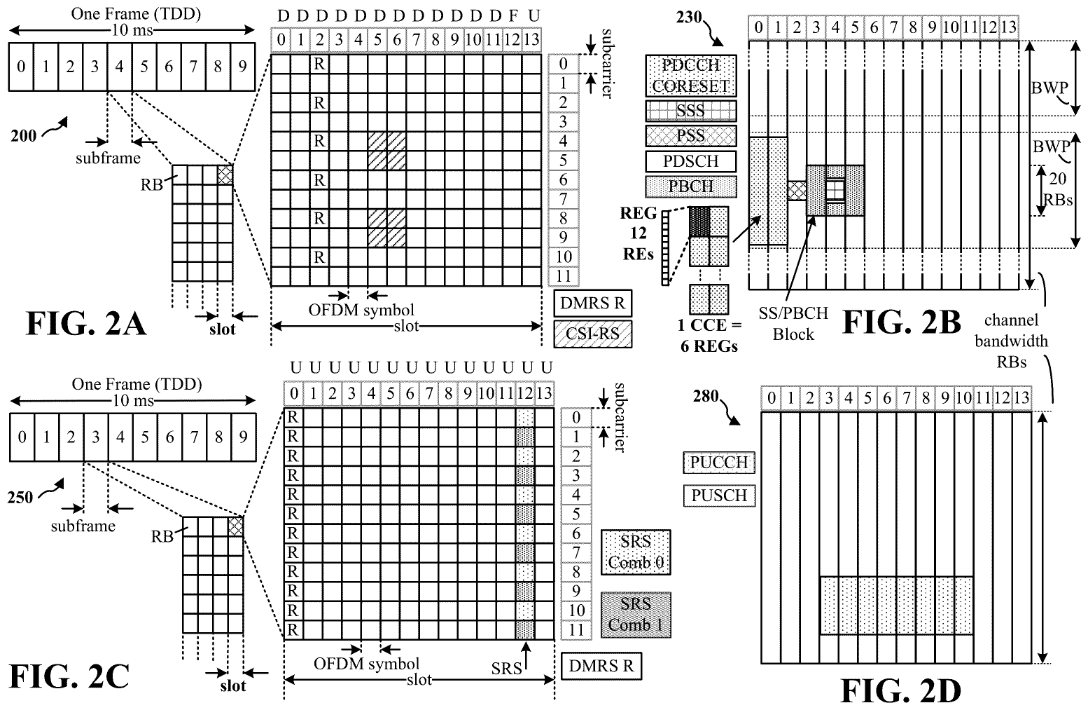

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information ir (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

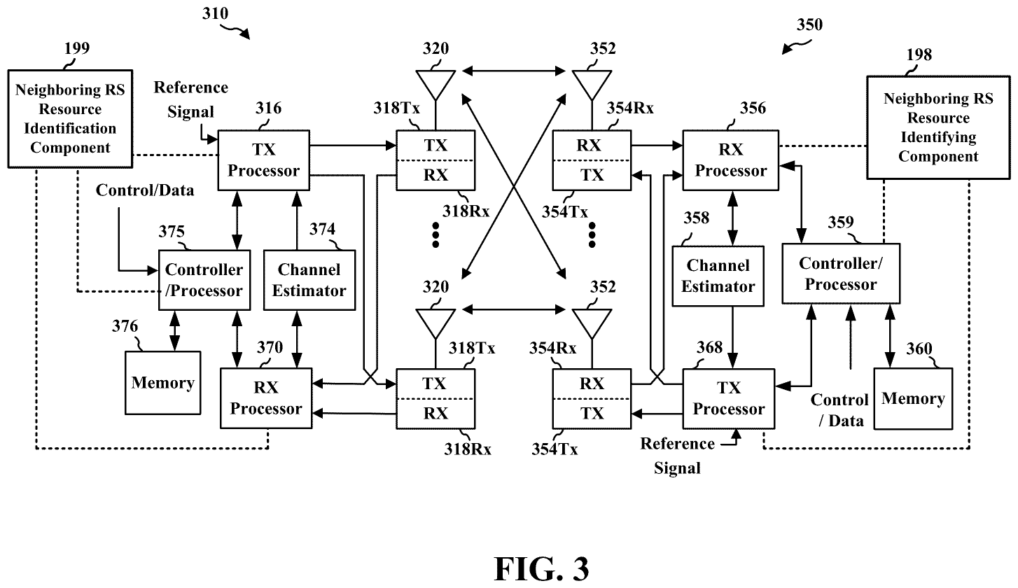

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the neighboring RS resource identification component 198 of FIG. 1. At least one of the TX processor 316, the RX processor 370, and the controller/processor 375 may be configured to perform aspects in connection with the neighboring RS resource identifying component 199 of FIG. 1.

A UE trying to access a communication network may follow a cell search procedure that may include a series of synchronization stages. In some examples, the synchronization stages may enable the UE to determine time and/or frequency resources that may be useful for demodulating downlink signals, transmitting with the correct timing, and/or acquiring system information. Synchronization signal blocks (SSBs) may include a primary synchronization signal (PSS), a secondary synchronization signal (SSS), and a physical broadcast channel (PBCH). The UE may use the PSS to determine symbol timing and a physical layer identity. The UE may use the SSS to determine a physical layer cell identity group number (e.g., a “cell identifier”) and radio frame timing. The PBCH may carry a master information block (MIB), which may provide a number of resource blocks in the system bandwidth and a system frame number.

The SSBs may be transmitted (e.g., transmitted by a base station) at predetermined locations (e.g., time locations) within an SSB period, and the maximum number of SSBs may depend on the frequency band. In some examples, each SSB may be transmitted on a different beam, and the UE may search for all of the SSBs until the UE identifies a suitable SSB (e.g., an SSB associated with a satisfactory measurement). In certain such examples, once the UE identifies a suitable SSB, the UE may read the PBCH and then acquire the SIB (e.g., SIB1), which may indicate how many SSBs are transmitted. For example, as mentioned above, the SSB may include a PSS, an SSS, and PBCH. The UE may obtain symbol timing from the PSS. The UE may then obtain the cell identifier from the SSS. The UE may then read the MIB that is encoded in the PBCH, which may include information used to read SIBs. The UE may then acquire the SIB1. After the UE is operating in a connected mode, the base station may indicate which SSBs are transmitted via a separate dedicated RRC configuration, which may be more detailed than (and may, thus, override) the indication in SIB1.

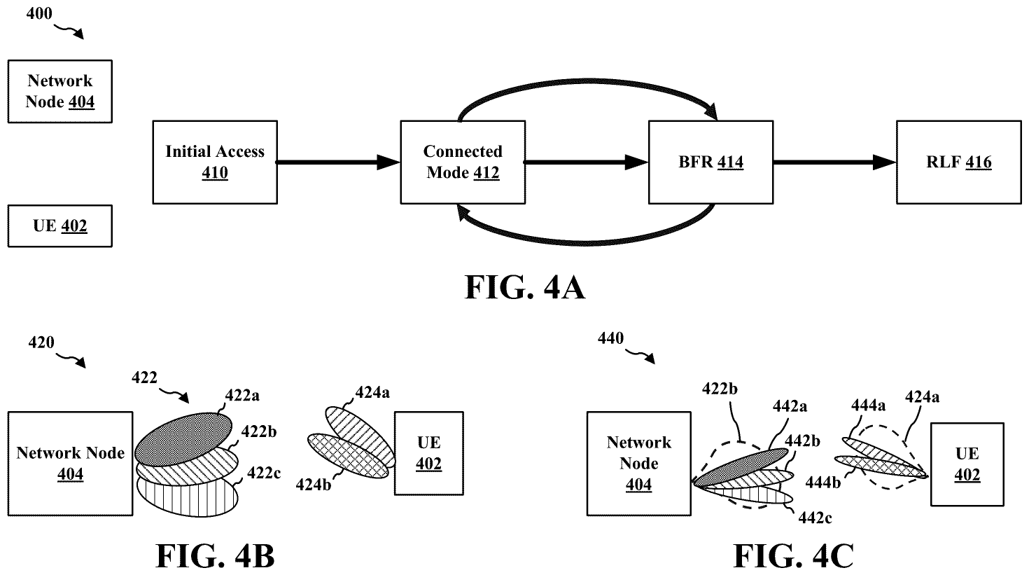

In some examples, to perform beam management procedures, a UE may measure SSBs to facilitate performing a random access channel (RACH) procedure with a base station. FIG. 4A illustrates an example flow diagram 400 of a beam management procedure for a base station 402 and a UE 404, as presented herein. In the illustrated example of FIG. 4A, the UE 404 may perform an initial access procedure 410 to establish a connected mode state 412 with a communication network (e.g., the base station 402). For example, the initial access procedure 410 may include the base station 402 performing SSB beam sweeping in which the base station 402 may transmit SSBs in different directions and/or angles to facilitate analog beam forming. As used herein, the terms “SSB” and “beams” may be used interchangeably, except when indicated. The UE 404 may receive one or more SSBs, perform measurements on the received SSBs, and select a strongest SSB based on the measurements. The SSBs may be associated with wide beams (e.g., a physical layer (L1) beams). The UE 404 may then perform the RACH procedure with the base station 402 based on the selected SSB. For example, the UE 404 may transmit a preamble corresponding to the selected SSB.

FIG. 4B illustrates an example of SSB beam sweeping 420 between the base station 402 and the UE 404, as presented herein. In the example of FIG. 4B, the base station 402 transmits an SSB burst set 422 including a first beam 422a, a second beam 422b, and a third beam 422c. The UE 404 may perform measurements on the received beams and indicate a strongest beam. As shown in FIG. 4B, the UE 404 receives a first beam 424a and a second beam 424b. In some examples, based on the indicated strongest beam, the base station 402 and the UE 404 may establish a beam pair link. For example, to facilitate downlink communication from the base station 402 to the UE 404, the base station 402 may transmit the downlink communication using the second beam 422b and the UE 404 may receive the downlink communication using the first beam 424a. In such examples, the selected beam pair (e.g., the second beam 422b and the first beam 424a) may be referred to as a beam pair link.

However, in such scenarios, the UE 404 may perform measurements on multiple SSBs before selecting the strongest beam, which may also increase latency as the quantity of SSBs may be large. To improve performance of the beam management procedure, in some examples, the UE 404 may be configured to measure a reduced quantity of SSBs (e.g., a subset of the SSBs). For example, the base station 402 may transmit sixteen beams, but the UE 404 may measure four of the beams.

After the initial access procedure 410 is complete, the UE 404 may operate in the connected mode state 412. While operating in the connected mode state 412, the base station 402 and the UE 404 may perform beam refinement procedures. In some examples, such procedures may be referred to as “sunny day operations.” In some examples, the beam refinement procedures may include hierarchical beam refinement. In some examples, the beam refinement procedures may include U1, U2, U3 procedures. The base station 402 and the UE 404 may transmit layer 1 reports to facilitate the beam refinement.

FIG. 4C illustrates an example of beam refinement 440 between the base station 402 and the UE 404, as presented herein. In the example of FIG. 4C, the base station 402 and the UE 404 perform a CSI-RS beam sweep. For example, the base station 402 may transmit a first CSI-RS 442a, a second CSI-RS 442b, and a third CSI-RS 442c. As shown in FIG. 4C, the first CSI-RS 442a, the second CSI-RS 442b, and the third CSI-RS 442c are narrower beams within the second beam 422b selected at the base station 402 for the beam pair link. The UE 404 may perform measurements on CSI-RS received at narrower beams within the first beam 424a selected at the UE 404 for the beam pair link. For example, the UE 404 may perform measurements on a first beam 444a and a second beam 444b that are narrower beams than the first beam 424a. The base station 402 and the UE 404 may then select another beam pair link based on the narrower beams. It may be appreciated that the base station 402 and the UE 404 may communicate using the wider beams, as shown in FIG. 4B, and/or using the narrower beams, as shown in FIG. 4C.

Returning to the flow diagram of FIG. 4A, while operating in the connected mode state 412, the base station 402 and the UE 404 may experience a beam failure. For example, a selected beam of the beam pair link may become blocked. In such examples, the base station 402 and the UE 404 may perform a beam failure recovery (BFR) procedure. For example, the base station 402 and the UE 404 may perform a BFR procedure 414 to facilitate a fast recovery from the beam failure.

In some examples, when the BFR procedure 414 is successful, the UE 404 returns to operating in the connected mode state 412. However, in some examples, the BFR procedure 414 may be unsuccessful. For example, the base station 402 and the UE 404 may experience radio link failure (RLF). In such examples, the base station 402 and the UE 404 may perform an RLF procedure 416 to attempt to reestablish a radio link. In some examples, the RLF procedure 416 may be a last resort for the base station 402 and the UE 404 in attempting to maintain a connection.

As described above, a beamforming technology (e.g., 5G NR mmW technology) may use beam management procedures, such as beam measurements and beam switches, to maintain a quality of a link between a first device and a second device (e.g., an access link between a base station and a UE or a sidelink communication link between a first UE and a second UE) at a sufficient level. Beam management procedures aim to support mobility and the selection of the best beam pairing (or beam pair link (BPL)) between the first device and the second device. Beam selection may be based on a number of considerations including logical state, power saving, robustness, mobility, throughput, etc. For example, wide beams (e.g., the example beams of FIG. 4B) may be used for initial connection and for coverage/mobility, while narrow beams (e.g., the example beams of FIG. 4C) may be used for high throughput scenarios with low mobility.

In some aspects, AI/ML may be implemented for air-interface corresponding to various target use cases such as performance, complexity, and potential specification impact. The use cases may include a channel state information (CSI) feedback enhancement (e.g., overhead reduction, accuracy improvement, or prediction) beam management (e.g., beam prediction in time, and/or spatial domain for overhead and latency reduction, beam selection accuracy improvement), or positioning accuracy enhancements for different scenarios including (e.g., with heavy NLOS conditions), and the AI/ML may be further implemented for characterization and baseline performance evaluations.

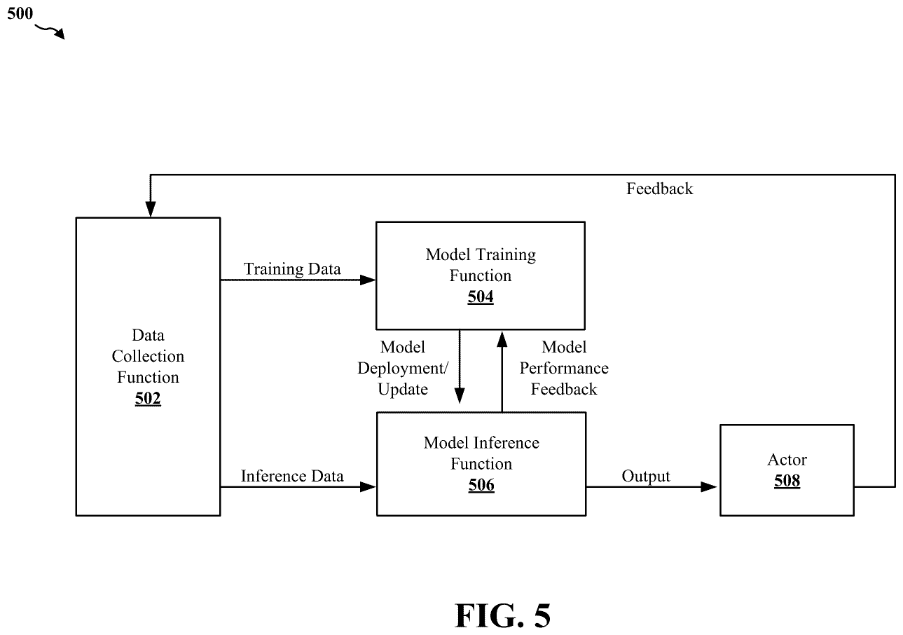

FIG. 5 is an example of the AI/ML algorithm 500 of a method of wireless communication. The AI/ML algorithm 500 may include various functions including a data collection function 502, a model training function 504, a model inference function 506, and an actor 508.

The data collection function 502 may be a function that provides input data to the model training function 504 and the model inference function 506. The data collection function 502 may include any form of data preparation, and it may not be specific to the implementation of the AI/ML algorithm (e.g., data pre-processing and cleaning, formatting, and transformation). The examples of input data may include, but not limited to, measurements from network entities including UEs or network nodes, feedback from the actor 508, output from another AI/ML model. The data collection function 502 may include training data, which refers to the data to be sent as the input for the model training function 504, and inference data, which refers to be sent as the input for the model inference function 506.

The model training function 504 may be a function that performs the ML model training, validation, and testing, which may generate model performance metrics as part of the model testing procedure. The model training function 504 may also be responsible for data preparation (e.g. data pre-processing and cleaning, formatting, and transformation) based on the training data delivered or received from the data collection function 502. The model training function 504 may deploy or update a trained, validated, and tested AI/ML model to the model inference function 506, and receive a model performance feedback from the model inference function 506.

The model inference function 506 may be a function that provides the model inference output (e.g. predictions or decisions). The model inference function 506 may also perform data preparation (e.g. data pre-processing and cleaning, formatting, and transformation) based on the inference data delivered from the data collection function 502. The output of the model inference function 506 may include the inference output of the AI/ML model produced by the model inference function 506. The details of the inference output may be use-case specific.

The model performance feedback may refer to information derived from the model inference function 506 that may be suitable for improvement of the AI/ML model trained in the model training function 504. The feedback from the actor 508 or other network entities (via the data collection function 502) may be implemented for the model inference function 506 to create the model performance feedback.

The actor 508 may be a function that receives the output from the model inference function 506 and triggers or performs corresponding actions. The actor 508 may trigger actions directed to network entities including the other network entities or itself. The actor 508 may also provide a feedback information that the model training function 504 or the model inference function 506 to derive training or inference data or performance feedback. The feedback may be transmitted back to the data collection function 502.

A UE and/or network entity (centralized and/or distributed units) may use machine-learning algorithms, deep-learning algorithms, neural networks, reinforcement learning, regression, boosting, or advanced signal processing methods for aspects of wireless communication, e.g., with a base station, a TRP, another UE, etc.

In some aspects described herein, an encoding device (e.g., a UE) may train one or more neural networks to learn dependence of measured qualities on individual parameters. Among others, examples of machine learning models or neural networks that may be comprised in the UE and/or network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivates, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times.

In some aspects, the AI/ML model may be implemented for beam management. In one aspect, the beam management may include reporting the strongest physical layer reference signal received power (L1-RSRPs). In another aspect, the beam management may include reporting the L1-RSRP of the reference signals that are not the strongest. In one aspect, to collect data and/or labels for beam prediction or to predict at the network node side based on the UE reported L1-RSRPs, some less significant L1-RSRP measurements may need to be considered and play comparably more important roles than the strongest L1-RSRP measurement report.

For example, in a beam blockage prediction, for the network node to perform the beam prediction at the network node side, a vectorized RSRP fingerprint time series may be used to predict the blockage instance/severity/direction of the beam, and to perform the prediction of the blockage, less significant L1-RSRP measurements may be relatively more important role than the strongest L1-RSRP measurement report. In one aspect, the network node may instruct the UE to report the L1-RSRP measurements of target RS resources by instructing or ordering RS-IDs of the target RS resources to be measured and reported by the UE. To instruct or order the RS-IDs, the network node may be configured with an additional configuration overhead or indication overhead. Here, the configuration overhead may be provided for configuring the instruction of the RS-IDs of the target RS resources for measurement and reporting, and the indication overhead may be provided for dynamic alternation or activation of the configuration.

In another aspect, the UE may proactively determine the RS-IDs of the target RS resources to be measured and reported to the network node. The UE may be configured with an additional UE feedback overhead to indicate the additional RS-IDs.

In some aspects associated with multiple RS resources, the network node transmitted beams' angular neighboring behaviors may be used to reduce the UE feedback overhead. That is, based on the angular neighboring characteristics of the plurality of beams, the UE may determine the beams that are neighboring a target beam for various reporting implementations. For example, beams that are close to the strongest beam may be used to reflect more information on channel characteristics. That is, with reference to the strongest beam (e.g., beam associated with the strongest L1-RSRP measurement), the beams that are close (e.g., neighboring beams that have relatively smaller angular difference with respect to the strongest beam than other beams) may provide useful information with regards to the channel characteristics.

In one aspect, the network node may explicitly indicate beam pointing direction in azimuth and elevation angles, including azimuth angle of departure (AoD) and/or zenith angle of departure (ZoD) information of each beam, and the UE may understand or determine which beams are the neighboring beams of the target beam. However, the information of beam pointing direction in azimuth and elevation angles may be part of the infrastructural configuration of each network node, which may not be subject to disclosure.

In another aspect, the network may explicitly signal the neighboring RSs that may be associated with a target RS resources and avoid disclosing implementation details of the beam pointing direction in azimuth and elevation angles of each beams associated with the RSs. Accordingly, once the UE identifies the target RS based on the L1-RSRP strength, the UE may adaptively identify the associated “neighboring” RSs based on the configuration received from the network node and report their RSRPs, without an additional overhead.

In some aspects, the network may explicitly signal a neighboring RS resource configuration associated with an RS resource set (e.g., CSI-RS/SSB resource set). That is, the neighboring RS resource configuration may provide indications of neighboring RS resources for each target RS resources (e.g., target CSI-RS/SSB resources). In one aspect, the neighboring RS resource configuration may be implicitly provided based on the information of beam pointing direction in azimuth and elevation angles disclosed by the network node. In another aspect, the neighboring RS resource configuration may be applied to different AI/ML model assisted beam management procedures.

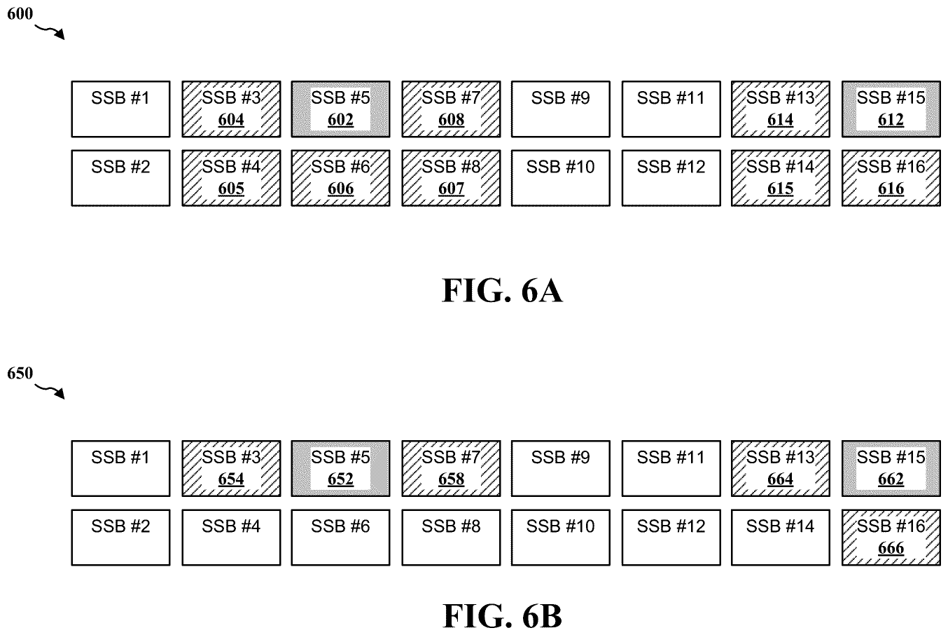

FIGS. 6A and 6B are sets of RS resources 600 and 650 of a method of wireless communication. The network node may transmit a neighboring RS resource configuration to the UE, the neighboring RS resource configuration may, for each “target” RS resource (e.g., CSI-RS/SSB resource) within a RS resource set, explicitly configure or indicate the UE with one or multiple RS resources that are neighbored or neighboring with the target RS resource.

Here, the RS resources may be SSB resources. The first set of RS resources 600 may include SSB resources, and include 16 SSBs (e.g., SSB #1 to SSB #16). For each SSB resource within the SSB resource set including 16 SSBs, the UE may identify the “neighboring” SSB resources for each “target” SSB resource based on the neighboring RS configurations received from the network node. That is, the network node may indicate that the neighboring SSB resources for SSB #1 are SSB #2, SSB #3, and SSB #4, the neighboring SSB resources for SSB #2 are SSB #1, SSB #3, and SSB #4, the neighboring SSB resources for SSB #3 are SSB #1, SSB #2, SSB #4, SSB #5, and SSB #6, . . . , the neighboring SSB resources for SSB #15 are SSB #13, SSB #14, and SSB #16, and the neighboring SSB resources for SSB #16 are SSB #13, SSB #14, and SSB #15.

FIG. 6A is a first set of RS resources 600 of a method of wireless communication. In some aspects, the neighboring RS configuration is signaled based on bitmaps. For each target RS resource (e.g., CSI-RS/SSB resource) within the RS resource set, a bitmap may be used to indicate the associated neighboring RS resources. That is, the neighboring RS configuration for a set of RS resources may include at least one bitmap indicating the neighboring RS resources for each RS resource of the set of RS resources.

In one aspect, a full bitmap may be implemented to indicate the neighboring RS resource configuration. Here, the bit-width of the bitmap equals to N_{resource}−1, wherein N_{resource} stands for the total number of RS resources (e.g., CSI-RS/SSB resources) within the RS resource set.

In another aspect, a reduced bitmap may be implemented to indicate the neighboring RS resource configuration. Here, the bit-width of the bitmap N_{resource} may be restricted to a number of RS resources (e.g., CSI-RS/SSB resources) comprising IDs close to the target RS resource, wherein the value of N_{resource} can be further RRC configured. That is, the network node may configure the N_{resource} using RRC signaling.

The bits within the bitmap may be associated with the remaining RS resources (e.g., RS resources other than the target RS resource) within the RS resource set, except for the “target” CSI-RS/SSB resource, in one of an ascending order or a descending order of the RS resources. A bit value associated with a certain remaining RS resource may represent whether the RS resource is a neighboring RS resource of the target RS resource. In one example, a bit value associated with a first remaining RS resource being 1 may indicate that the first remaining RS resource is one of the neighboring RS resource of the target RS resource. In another example, a bit value associated with a second remaining RS resource being 0 may indicate that the second remaining RS resource is not a neighboring RS resource of the target RS resource. The total number of “1”s within the bitmaps can be network node further configured.

Referring to FIG. 6A, the first set of RS resources 600 may include a first target RS resource 602 (e.g., SSB #5) and a second target RS resource 612 (e.g., SSB #15), and a first set of neighboring RS resources 604 (e.g., SSB #3), 605 (e.g., SSB #4), 606 (e.g., SSB #6), 607 (e.g., SSB #8), and 608 (e.g., SSB #7), and a second set of neighboring RS resources 614 (e.g., SSB #13), 615 (e.g., SSB #14), and 616 (e.g., SSB #16). The following table indicates an example neighboring RS resource configuration including the full bitmap and the reduced bitmap. The RE resource set includes 16 RS resources, and the N_{resource} of the full bitmap may be 15, and the reduced bitmap may be 7. The number of neighboring RS resources for each RS resource may be configured as 5, which means that each RS resource is associated with 5 neighboring RS resources.

Referring to SSB #5 (e.g., the first target RS resource 602), a first full bitmap associated with the index value 5 is 0011 111 0000 0000, indicating that the neighboring RS resources of the SSB #5 are SSB #3 (e.g., 604), SSB #4 (e.g., 605), SSB #6 (e.g., 606), SSB #7 (e.g., 608), and SSB #8 (e.g., 607). A first reduced bitmap associated with the index value 5 is 0011 111, indicating that the neighboring RS resources of the SSB #5 are SSB #3 (e.g., 604), SSB #4 (e.g., 605), SSB #6 (e.g., 606), SSB #7 (e.g., 608), and SSB #8 (e.g., 607).

Referring to SSB #15 (e.g., the second target RS resource 612), a second full bitmap associated with the index value 16 is 0000 0000 0000 111, indicating that the neighboring RS resources of the SSB #15 are SSB #13 (e.g., 614), SSB #14 (e.g., 615), and SSB #16 (e.g., 616). A second reduced bitmap associated with the index value 5 is 0000 111, indicating that the neighboring RS resources of the SSB #15 are SSB #13 (e.g., 614), SSB #14 (e.g., 615), and SSB #16 (e.g., 616).

| Target SSB | Full Bitmap | Reduced Bitmap |
|---|---|---|
| Index | (N_{resource} = 15) | (N_{resource} = 7) |
| 1 | 111 0000 0000 0000 | 111 0000 |
| 2 | 111 0000 0000 0000 | 111 0000 |
| 3 | 111 1100 0000 0000 | 111 1100 |
| 4 | 111 1100 0000 0000 | 111 1100 |
| 5 | 0011 111 0000 0000 | 0011 111 |
| . . . | . . . | . . . |
| 15 | 0000 0000 0000 111 | 0000 111 |
| 16 | 0000 0000 0000 111 | 0000 111 |

FIG. 6B is a second set of RS resources 650 of a method of wireless communication. In some aspects, the neighboring RS configuration is signaled based on a set of RS IDs. For each “target” RS resource within the RS resource set, a number of (namely N_{neighbor-per-target}) RS resource IDs may be signaled as the associated “neighboring” RS resources (e.g., CSI-RS/SSB resources). The value of N_{neighbor-per-target} may be determined based on further network node configurations associated with the RS resource set.

In one aspect, in a full bit-width, the bit-width may be used to indicate the RS resource ID for each neighboring CSI-RS/SSB resource, based on log₂ (N_{resource}−1), wherein the N_{resource} stands for the total number of RS resources (e.g., CSI-RS/SSB resources) within the RS resource set.

In another aspect, a reduced bit-width N_{resource} may be implemented to indicate the neighboring RS resource configuration. That is, the bit-width may be restricted to a number of RS resources (e.g., CSI-RS/SSB resources) comprising the IDs close to the “target” CSI-RS/SSB resource, wherein the value of N_{resource} may be further RRC configured. That is, for each target CSI-RS/SSB resource, the potential neighboring RS resources (e.g., CSI-RS/SSB resources) may be re-indexed based on the remaining RS resources (e.g., CSI-RS/SSB resources) IDs in an ascending order or a descending order, such that the N_{neighbor-per-target} signaled neighboring indices are referring to the re-indexed IDs associated with the remaining CSI_RS/SSB resources.

Referring to FIG. 6B, the first set of RS resources 650 may include a first target RS resource 652 (e.g., SSB #5) and a second target RS resource 662 (e.g., SSB #15), and a first set of neighboring RS resources 654 (e.g., SSB #3) and 658 (e.g., SSB #7), and a second set of neighboring RS resources 664 (e.g., SSB #13) and 666 (e.g., SSB #16). The following table indicates an example neighboring RS resource configuration including the full bitmap and the reduced bitmap. The RE resource set includes 16 RS resources, and the N_{resource} of the full bitmap may be 15, and the reduced bitmap may be 5. The number of neighboring RS resources for each RS resource may be configured as 2, which means that each RS resource is associated with 2 neighboring RS resources.

Referring to SSB #5 (e.g., the first target RS resource 652), the first neighboring SSB indices with the full bit-width may indicate that the neighboring RS resources of the SSB #5 are SSB #3 (e.g., 654) and SSB #7 (e.g., 658). A first neighboring SSB indices with the reduced bit-width may indicate that the neighboring RS resources of the SSB #5 are SSB #3 (e.g., 654) and SSB #7 (e.g., 658).

Referring to SSB #15 (e.g., the second target RS resource 662), a second neighboring SSB indices with the full bit-width may indicate that that the neighboring RS resources of the SSB #15 are SSB #13 (e.g., 664) and SSB #16 (e.g., 666). A second neighboring SSB indices with the reduced bit-width may indicate that the neighboring RS resources of the SSB #15 are SSB #13 (e.g., 664) and SSB #16 (e.g., 666).

| | Neighboring SSB Indices (N_{resource-per-target} = 2) | |
|---|---|---|
| | Full Bitmap (N_{resource} = 15): | Reduced Bitmap (N_{resource} = 5): |
| Target | 2 SSB indices (each using | 2 SSB indices (each using |
| SSB | [log₂ 15] = 4 bits) | [log₂ 4] = 2 bits) |
| Index | out of 15 ones | out of 4 ones |
| 1 | 2 3 4 5 . . . 6 | 2 3 4 5 |
| 2 | 1 3 4 . . . . 16 | 1 3 4 5 |
| 3 | 1 2 4 5 . . . 16 | 1 2 4 5 |
| . . . | . . . | . . . |
| 16 | 1 2 . . . 13 14 15 | 12 13 14 15 |

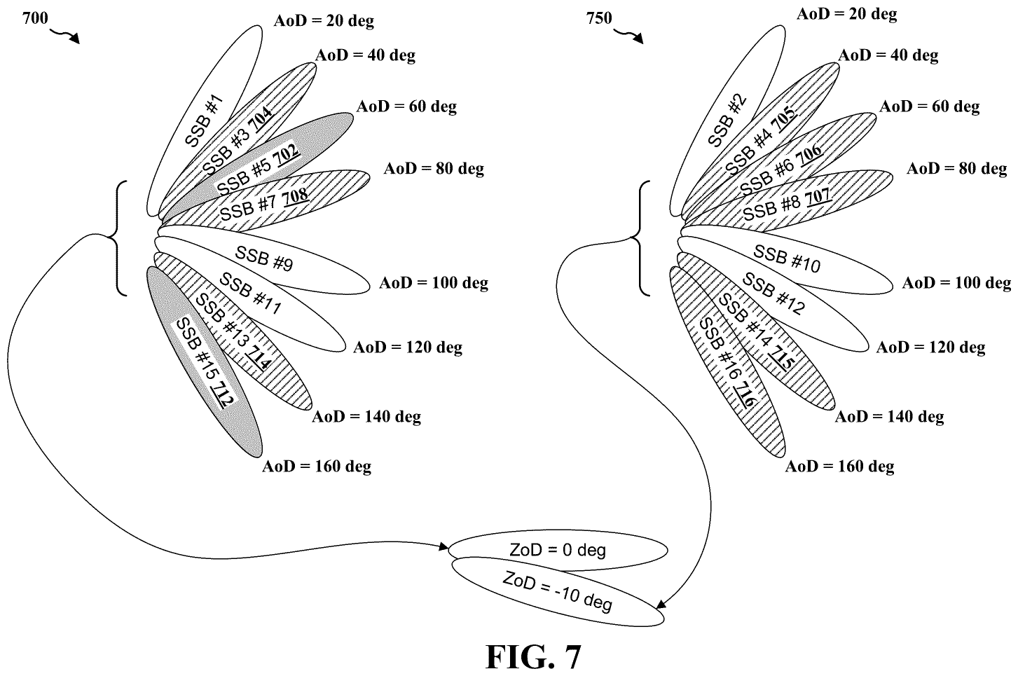

FIG. 7 is sets of RSs 700 and 750 of a method of wireless communication. The two sets of reference signals may include a first set of RSs 700 and a second set of RSs 750. Each of the first set of RSs 700 and the second set of RSs 750 may include multiple RS resources (e.g., SSB) transmitted in different AoDs. (e.g., 20, 40, 60, 80, 100, 120, 140, and 160 degrees). The first set of RSs 700 may be transmitted at a first ZoD of 0 degree, and the second set of RSs 750 may be transmitted at a second ZoD of −10 degrees.

In some aspects, the precoding information of the RS resources (e.g., CSI-RS/SSB resources) within the RS resource set may be additionally configured with information of beam point direction in azimuth or elevation angles (e.g., AoD/ZoD) for the RS resource set. In one example, the beam point direction information of each RS resources may be additionally configured for the precoding a part of the neighboring RS configuration.

Accordingly, the neighboring RS resources (e.g., CSI-RS/SSB resources) for the target RS resource may be identified based on identifying the N_{neighbor-per-target} number of RS resources (e.g., CSI-RS/SSB resources) with the relatively smallest precoding difference (e.g., beam point direction in azimuth or elevation angles difference) with respect to the target RS resource. That is, the precoding difference may be correlated with the difference of the beam point direction information, and therefore, the UE may compare the precoding information of each RS resources with the precoding information of the target RS resource, and identify that a number of RS resources with the smallest precoding difference with the target RS resource to be the neighboring RS resources of the target RS resources. By comparing the precoding difference, which is based on the beam point direction information of each RS resources precoded for each RS resources, the UE may identify the neighboring RS resources of the target RS resource.

For example, referring to the set of RSs 700 and 750, in reference to FIG. 6A, may show that the SSB #5 702 (e.g., SSB #5 602) and the SSB #15 (e.g., SSB #5 612) are the target RS resources. Here, the first target resource SSB #5 702 may be associated with a first precoding information and the second target resource SSB #15 712 may be associated with a second precoding information. By comparing the precoding differences of the other RS resources with the first and second target information of the target RS resources, the UE may identify the neighboring RS resources for each of the target RE resource. For the first target resource SSB #5 702 (e.g., SSB #5 602), the UE may identify a first set of neighboring RS resources including the SSB #3 704 (e.g., SSB #3 604), the SSB #4 705 (e.g., SSB #4 605), the SSB #6 706 (e.g., SSB #6 606), the SSB #8 707 (e.g., SSB #8 607), and the SSB #7 708 (e.g., SSB #7 608) as the neighboring RS resources of the first target resource SSB #5 702 for having the smallest precoding differences with the first precoding information of the first target resource SSB #5 702. For the second target SSB #15 712 (e.g., SSB #15 612), the UE may identify a first set of neighboring RS resources including the SSB #13 714 (e.g., SSB #13 614), the SSB #14 715 (e.g., SSB #14 615), the SSB #16 716 (e.g., SSB #16 616), as the neighboring RS resources of the second target resource SSB #15 712 for having the smallest precoding differences with the second precoding information of the second target resource SSB #5 702.

In some aspects, various implementation may be provided in identifying the neighboring RS resources. In one aspect, the UE may prioritize the AoD over ZoD (or vice versa). In another aspect, the UE may determine the neighboring RS resources based on (AOD_{difference}+ZOD_{difference}). In another aspect, the UE may determine the neighboring RS resources based on a 3D angular difference considering the vector of AoD+ZoD. Also, the value of the N_{neighbor-per-target} may be determined based on further network node configurations associated with the RS resource set.

In some aspects, the neighboring RS resource configuration indicating the neighboring RS resources for a target RS resource may be configured for data collection or network node-based ML inference. That is, the neighboring RS resource configuration may be signaled by a CSI report setting or by a CSI resource setting associated with the CSI report setting, wherein the RS resource set is a CSI-RS/SSB resource set associated with the CSI report/resource setting and is used for channel measurement.

In one aspect, the UE may report the physical layer (L1) RSRP (L1-RSRP) and/or an L1 signal to interference plus noise ratio (SINR) (L1-SINR) of the neighboring CSI-RS/SSB resources associated with the target RS resource with the strongest L1-RSRPs/L1-SINRs of the target CSI-RS/SSB resources. First, the UE may report the strongest L1-RSRPs/L1-SINRs & the associated IDs of the CSI-RS/SSB resources, where such CSI-RS/SSB resources may be taken as the target CSI-RS/SSB resources. Then UE may identify respective neighboring CSI-RS/SSB resources associated with the target CSI-RS/SSB resources, and may further report the L1-RSRPs/L1-SINRs of the respective neighboring CSI-RS/SSB resources.

In one example, the UE may transmit a second report of the L1-RSRPs/L1-SINRs of the neighboring CSI-RS/SSB resources, by referring the associated target CSI-RS/SSB resources. Since the second report of the L1-RSRPs/L1-SINRs are associated with the target CSI-RS/SSB resources, the network node may successfully understand that the reported L1-RSRPs/L1-SINRs are the reports of the neighboring CSI-RS/SSB resources associated with the target CSI-RS/SSB resources. The UE may omit the IDs of the “neighboring” CSI-RS/SSB resources do not need to be further reported.

In another aspect, the UE may report L1-RSRP/L1-SINR of neighboring RS resources associated with the RS resource that the network node ordered the L1-RSRPs/L1-SINRs report. That is, the network node may indicate the target RS resource for the UE to measure and report the measurement, and the UE may report the measurement of the neighboring RS resources associated with the target RS Resource.

The UE may first report the L1-RSRPs/L1-SINRs of the target CSI-RS/SSB resources, wherein the target CSI-RS/SSB resources are identified based on a configuration or indication from the network node. When the UE reports the L1-RSRPs/L1-SINRs of the target CSI-RS/SSB resources, the UE may omit the ID of the target CSI-RS/SSB resources since the network node ordered the report of the target CSI-RS/SSB resources.

The UE may identify the respective neighboring CSI-RS/SSB resources associated with the target CSI-RS/SSB resources. The neighboring CSI-RS/SSB resources may be identified based on the neighboring RS resource configuration received from the network node. Based on the identification of the respective neighboring CSI-RS/SSB resources associated with the target CSI-RS/SSB resources, the UE may further reports the L1-RSRPs/L1-SINRs of the respective neighboring CSI-RS/SSB resources associated with the target CSI-RS/SSB resources.

The UE may transmit a second report of the L1-RSRPs/L1-SINRs of the respective neighboring CSI-RS/SSB resources associated with the target CSI-RS/SSB resources, referring to the associated target CSI-RS/SSB resources. The UE may omit the IDs of the neighboring CSI-RS/SSB resources when transmitting the second report of the L1-RSRPs/L1-SINRs of the respective neighboring CSI-RS/SSB resources. The network node ordered the report of the target CSI-RS/SSB resources, and may recognize that the second report is the L1-RSRPs/L1-SINRs of the respective neighboring CSI-RS/SSB resources associated with the target CSI-RS/SSB resources.

In some aspects, the neighboring RS resource configuration indicating the neighboring RS resources for a target RS resource may be configured for implementation of the UE based AI/ML model.

In one aspect, the neighboring RS resource configuration may indicate the neighboring RS resources associated with the target RS resource, and the UE may use the neighboring RS resource configuration to perform the AI/ML model assisted spatial/time/frequency domain beam prediction via CSI reporting.

The neighboring RS configuration may be signaled by a CSI report setting or by a CSI resource setting associated with the CSI report setting, and the RS resource set may be the CSI-RS/SSB resource set associated with the CSI report/resource setting and is used for channel measurement.

The UE may identify the strongest L1-RSRPs/L1-SINRs and the associated IDs of the CSI-RS/SSB resources, and the corresponding CSI-RS/SSB resources may be identified as the target CSI-RS/SSB resources. The UE may identify the respective neighboring CSI-RS/SSB resources associated with the identified target CSI-RS/SSB resources based on the neighboring RS resource configuration, and measure the L1-RSRPs/L1-SINRs of the identified neighboring CSI-RS/SSB resources associated with the target CSI-RS/SSB resources.

The UE may further use a network configured AI/ML model to predict spatial/time/frequency domain channel characteristics (e.g., spatial/time/frequency domain L1-RSRP/L1-SINR prediction, time/frequency domain beam failure/blockage prediction, time-domain CQI prediction, etc.). Here, the AI/ML model may be based at least on (A) the IDs and L1-RSRPs/L1-SINRs of the UE identified target CSI-RS/SSB resources, and/or (B) the L1-RSRPs/L1-SINRs of the UE identified neighboring CSI-RS/SSB resources. The AI/ML-model's output may include the spatial/time/frequency domain predicted channel characteristics. The UE may report the predicted channel characteristics via the CSI reports on the UCI, based on the AI/ML model output and associated configurations in the CSI report setting.

In another aspect, the neighboring RS resource configuration may indicate the neighboring RS resources associated with the target RS resource, and the UE may use the neighboring RS resource configuration to perform the AI/ML model assisted time/frequency domain beam failure/blockage prediction via beam failure detection (BFD) mechanisms.

The neighboring RS configuration may be signaled by the configurations of BFD-RS, and the RE resource set may be the CSI-RS/SSB resource set used as BFD-RS for time/frequency domain beam failure/blockage prediction.

The UE may identify the strongest L1-RSRPs/L1-SINRs and the associated IDs of the CSI-RS/SSB resources, and the corresponding CSI-RS/SSB resources may be identified as the target CSI-RS/SSB resources. The UE may the respective neighboring CSI-RS/SSB resources associated with the identified target CSI-RS/SSB resources based on the neighboring RS resource configuration, and measure the L1-RSRPs/L1-SINRs of the identified neighboring CSI-RS/SSB resources associated with the target CSI-RS/SSB resources.

The UE may further use a network configured AI/ML model to predict time/frequency domain beam failure/blockage. Here, the AI/ML-model's input may be based at least on (A) at least on the IDs and L1-RSRPs/L1-SINRs of the UE identified “target” CSI-RS/SSB resources and/or (B) the L1-RSRPs/L1-SINRs of the UE identified “neighboring” CSI-RS/SSB resources. The ML-model's output may include time/frequency domain beam failure/blockage predictions. UE may report the predicted beam blockage/failure instance via MAC-CE or UCI, based on the AI/ML-model output and further configurations in the BFD-RS.

In some aspects, the neighboring RS resource configuration indicating the neighboring RS resources for a target RS resource may be configured for implementation of inter-neighboring RS priority considerations.

When reporting L1-RSRPs/L1-SINRs associated with the neighboring CSI-RS/SSB resource, the reporting payload size may be fixed and may not be large enough to report all the measurements of the identified neighboring RS resources (e.g., CSI-RS/SSB resources) in the payload with the fixed payload size. The UE determine the priorities of the neighboring RS resources and omit or drop the L1-RSRPs/L1-SINRs associated with some of the neighboring RS resources (e.g., CSI-RS/SSB resources) based on the priority of the neighboring RS resources.

In one aspect, the UE may determine the priorities of the neighboring RS resources (e.g., CSI-RS/SSB resources) associated with different target RS resources (e.g., CSI-RS/SSB resources). In one example, the UE may assign higher priority for the neighboring RS resources based on the L1-RSRP/L1-SINR measurement of the associated target RS resource. That is, a first neighboring RS resource associated with a first target RS resource may have a higher priority than a second neighboring RS resource associated with a second target RS resource based on the first target RS resource having the higher L1-RSRP/L1-SINR measurement than the second target RS resource. In another example, the UE may assign higher priority for the neighboring RS resources based on the number of neighboring RS resources associated with the target RS resource. That is, a first neighboring RS resource associated with a first target RS resource may have a higher priority than a second neighboring RS resource associated with a second target RS resource based on the first target RS resource having a greater number of neighboring RS resources than the second target RS resource.

In another aspect, the UE may determine the priorities of the neighboring RS resources (e.g., CSI-RS/SSB resources) associated with the same target RS resources (e.g., CSI-RS/SSB resources). In one example, the UE may assign higher priority for the neighboring RS resources based on RS ID of the neighboring RS resource. That is, the neighboring RS resource with smaller/greater RS ID of the neighboring RS resource may have the higher priority. In another example, if beam point direction in azimuth or elevation angles based “neighboring” signaling is used, the UE may assign higher priority for the neighboring RS resources first based on the beam point direction in azimuth or elevation angles, and then prioritize based on smaller/greater RS resource ID.

In some aspects, multiple sets of parameters (e.g., values of N_{resource} or N_{neighbor-per-target}) associated with the proffered implementations may be preconfigured associated with SP/AP RS resource set (E.g., based on semi-persistent (SP) or aperiodic (AP) (SP/AP) CSI-RS activation/triggering state configurations). The activating/triggering of the CSI-RS resource set may also trigger the associated parameters, options, or implementations. The network node may dynamically indicate such parameters/options for SP/AP CSI-RS resource set via MAC-CE when activating such SP CSI-RS resource set, or via the DCI when triggering such AP CSI-RS resource set.

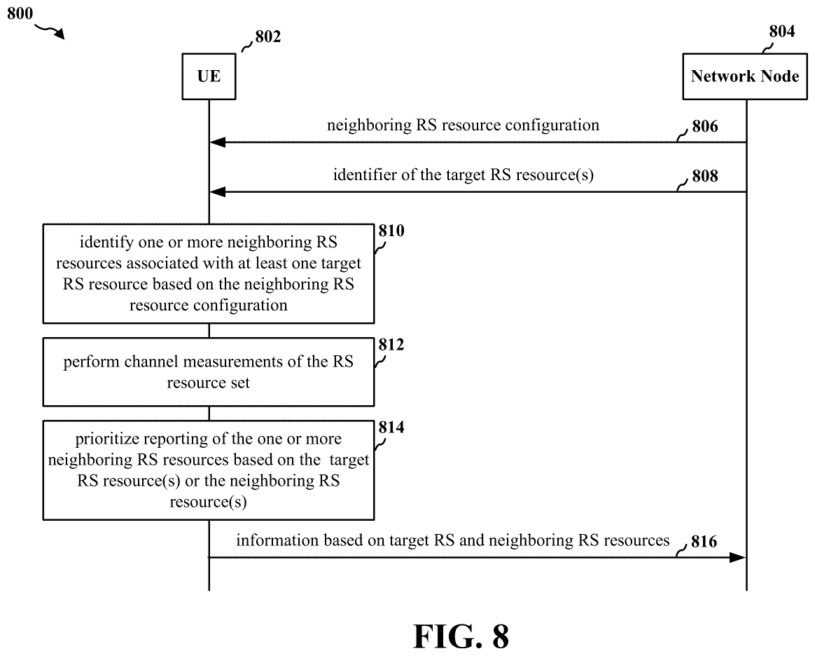

FIG. 8 is a call-flow diagram 800 of a method of wireless communication. The call-flow diagram 800 may include a UE 802 and a network node 804 with improve beam management. The UE 802 802 may be enabled to report not just measurements of a strongest beam, but also identify one or more neighboring beams associated with a target beam as a part of beam management and report the measurement of the one or more neighboring beams. The network node 804 may configure the UE 802.

At 806, the network node 804 may transmit a neighboring RS resource configuration associated with an RS resource set. The UE 802 may receive a neighboring RS resource configuration associated with an RS resource set. The resource set may include at least one of a CSI-RS resource set or an SSB resource set.

In one aspect, the neighboring RS resource configuration may include at least one bitmap, each bitmap indicating the one or more neighboring RS resources of a corresponding RS resource of the RS resource set. In one example, each bitmap may include a plurality of bits, each bit of the plurality of bits indicating whether each RS resource of the RS resource set is included in the one or more neighboring RS resources. In another example, the plurality of bits may include N−1 bits, wherein N refers to a total number of RS resources in the RS resource set, and each bitmap may indicate a subset of the RS resource set that is included in the one or more neighboring RS resources. In another example, each bitmap may include a plurality of bits, each bit of the plurality of bits indicating whether each RS resource of the subset of the RS resource set is included in the one or more neighboring RS resources. In another example, the neighboring RS resource configuration includes at least one RS ID, each of the at least one RS ID indicating the one or more neighboring RS resources of a corresponding RS resource of the RS resource set, and each of the at least one RS ID is associated with a bitmap indicating the one or more neighboring RS resources of the corresponding RS resource of the RS resource set.

The receiving of the neighboring RS resource configuration may further include receiving a set of neighboring RS resource configurations and receive an indication to activate one neighboring RS resource configuration among the set of neighboring RS resource configurations.

At 808, the network node 804 may transmit an identifier of the at least one target RS resource. The UE 802 may receive an identifier of the at least one target RS resource. Here, the network node 804 may instruct the UE 802 to measure the target RS resource or perform a AI/ML model based beam management. The UE 802 may, based on the RS ID of the target RS resource, measure the target RS resource, identify the associated neighboring RS resources, and perform the AI/ML model based beam management.

At 810, the UE 802 may identify one or more neighboring RS resources associated with at least one target RS resource based on the neighboring RS resource configuration. In one example, the UE 802 may perform channel measurements of the RS resource set and identify the at least one target RS resource based on the channel measurements of the RS resource set. In another example, the UE 802 may identify the target RS resource based on the RS ID of the target RS resources received at 808.

Here, the RS resource set may be associated with a set of beams, where the neighboring RS resource configuration may include precoding information associated with a direction of a corresponding beam among the set of beams, and the one or more neighboring RS resources may include a subset of RS resources among the RS resource set, the subset of RS resources having smallest precoding differences from the at least one target RS resource. The direction of the corresponding beam may be based on a first direction in azimuth angles and a second direction in elevation angles, and the subset of RS resources may have the smallest precoding difference from the at least one target RS resource based on at least one of the first direction or the second direction of the beams associated with the subset of RS resources.

At 812, the UE 802 may perform channel measurements of the RS resource set. The at least one neighboring RS resource may be identified based on the channel measurements of the RS resource set. The at least one channel measurement may include at least one of an L1-RSRP or an L1-SINR.

At 814, the UE 802 may prioritize reporting of the one or more neighboring RS resources based on at least one of the at least one target RS resource or the one or more neighboring RS resources. In one aspect, the at least one target RS resource may include a first target RS resource and a second target RS resource and one or more neighboring RS resources include a first neighboring RS resource set and a second neighboring RS resource set, and the at least one channel measurement may include the first neighboring RS resource set having a higher priority over the second neighboring RS resource set based on at least one of the first target RS resource having a greater channel measurement than the second target RS resource or the first neighboring RS resource set having a greater number RS resources than the second neighboring RS resource set. In another aspect, the one or more neighboring RS resources may include a first neighboring RS resource and a second neighboring RS resource associated with a first target RS resource, and the at least one channel measurement may include the first neighboring RS resource having a higher priority over the second neighboring RS resource based on a first ID of at least one of the first neighboring RS resource in comparison to a second ID of the second neighboring RS resource

At 816, the UE 802 may transmit information based on the at least one target RS resource and the one or more neighboring RS resources. The UE 802 may report at least one channel measurement of the one or more neighboring RS resources associated with the at least one target RS resource. The base station may obtain at least one channel measurement of the one or more neighboring RS resources associated with the at least one target RS resource. The UE 802 may report at least one channel measurement of the one or more neighboring RS resources associated with the at least one target RS resource. The neighboring RS resource configuration may be included in a CSI report setting or a CSI resource setting.

In some aspects, the UE 802 may receive a machine learning configuration that indicates the resource set. In one aspect, the UE 802 may transmit an indication of a predicted channel characteristic associated with at least one beam direction based on the machine learning configuration and the resource set. In another aspect, the UE 802 may transmit an indication of a predicted beam failure or a predicted beam blockage based on the machine learning configuration and the resource set, where the neighboring RS resource configuration is comprised in a BFD-RS configuration.

Here, the machine learning configuration may include at least one ML-model input including an identifier and a channel measurement of the at least one target RS resource or channel measurements of the one or more neighboring RS resources and at least one ML-model output including the predicted beam failure or the predicted beam blockage in one or more of a time domain or a frequency domain.

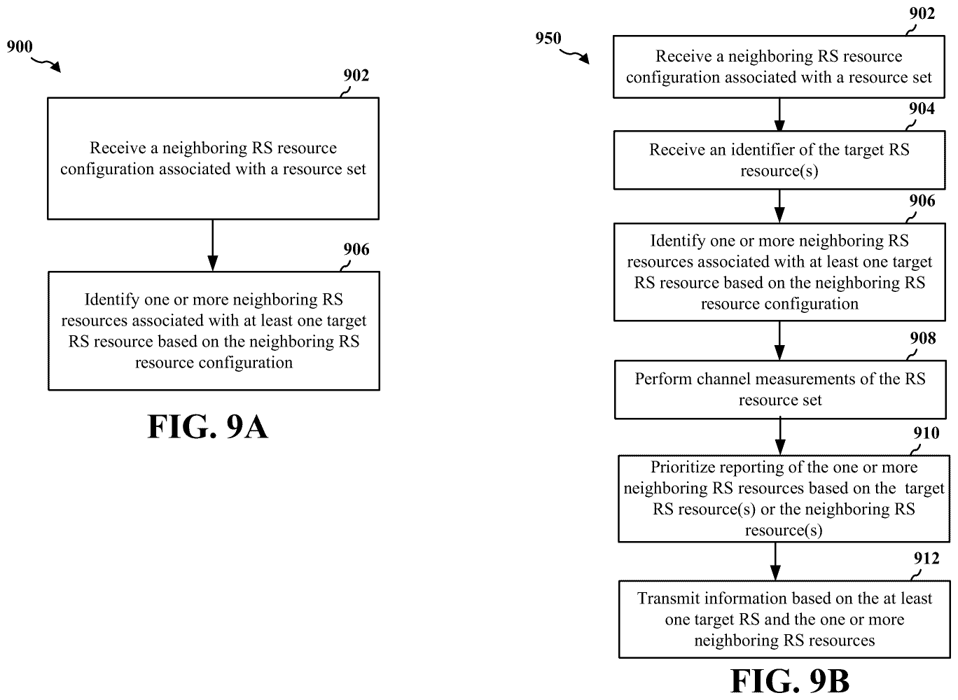

FIG. 9A is a flowchart 900 of a method of wireless communication. The method may be performed by a UE (e.g., the UE 104, 350, 802; the apparatus 1004). The method may improve beam management through enabling the UE to report not just measurements of a strongest beam, but also enabling the UE to identify one or more neighboring beams associated with a target beam as a part of beam management. The method may include any of the aspects described in connection with the UE in FIG. 8.

At 902, the UE receives a neighboring reference signal (RS) resource configuration associated with an RS resource set. The reception may be performed, e.g., by the neighboring RS resource identification component 198, the cellular baseband processor 1024, transceiver 1022, and/or antennas 1080. In some aspects, the resource set may include at least one of a CSI-RS resource set or an SSB resource set. The identification may include any of the aspects described in connection with FIGS. 4A-8. In some aspects, the neighboring RS resource configuration may include at least one bitmap, each bitmap indicating the one or more neighboring RS resources of a corresponding RS resource of the RS resource set. In some aspects, each bitmap may include a plurality of bits, each bit of the plurality of bits indicating whether each RS resource of the RS resource set is included in the one or more neighboring RS resources. As an example, the plurality of bits may include N−1 bits, where N refers to a total number of RS resources in the RS resource set. As an example, the bitmap may include a full bitmap. In other aspects, the bitmap may include a reduced bitmap. As an example, each bitmap may indicate a subset of the RS resource set that is included in the one or more neighboring RS resources. Each bitmap may include a plurality of bits, each bit of the plurality of bits indicating whether each RS resource of the subset of the RE resource set is included in the one or more neighboring RS resources. In some aspects, the neighboring RS resource configuration may include at least one RS ID, each of the at least one RS ID indicating the one or more neighboring RS resources of a corresponding RS resource of the RS resource set. For example, each of the at least one RS ID may be associated with a bitmap indicating the one or more neighboring RS resources of the corresponding RS resource of the RS resource set. As an example, for each target CSI-RS/SSB resource set within a CSI-RS/SSB resource set, a number of CSI-RS/SSB resource IDs may be signaled as associated neighboring CSI-RS/SSB resources.

At 906, the UE identifies one or more neighboring RS resources associated with at least one target RS resource based on the neighboring RS resource configuration. As an example, for a target CSI-RS/SSB resource, the UE may identify within a CSI-RS/SSB resource set, one or more neighboring CSI-RS/SSB resources. The identification may be performed, e.g., by neighboring RS resource identification component 198. The identification may include any of the aspects described in connection with FIGS. 4A-8.

FIG. 9B is a flowchart 950 of a method of wireless communication. The method may be performed by a UE (e.g., the UE 104, 350, 802; the apparatus 1004). The method may improve beam management through enabling the UE to report not just measurements of a strongest beam, but also enabling the UE to identify one or more neighboring beams associated with a target beam as a part of beam management. The method may include any of the aspects described in connection with the UE in FIG. 8.

At 902, the UE receives a neighboring RS resource configuration associated with an RS resource set, e.g., as described in connection with FIG. 9A. The reception may be performed, e.g., by the neighboring RS resource identification component 198, the cellular baseband processor 1024, transceiver 1022, and/or antennas 1080. In some aspects, the resource set may include at least one of a CSI-RS resource set or an SSB resource set. The identification may include any of the aspects described in connection with FIGS. 4A-8. In some aspects, the neighboring RS resource configuration may include at least one bitmap, each bitmap indicating the one or more neighboring RS resources of a corresponding RS resource of the RS resource set. In some aspects, each bitmap may include a plurality of bits, each bit of the plurality of bits indicating whether each RS resource of the RS resource set is included in the one or more neighboring RS resources. As an example, the plurality of bits may include N−1 bits, where N refers to a total number of RS resources in the RS resource set. As an example, the bitmap may include a full bitmap. In other aspects, the bitmap may include a reduced bitmap. As an example, each bitmap may indicate a subset of the RS resource set that is included in the one or more neighboring RS resources. Each bitmap may include a plurality of bits, each bit of the plurality of bits indicating whether each RS resource of the subset of the RE resource set is included in the one or more neighboring RS resources. In some aspects, the neighboring RS resource configuration may include at least one RS ID, each of the at least one RS ID indicating the one or more neighboring RS resources of a corresponding RS resource of the RS resource set. For example, each of the at least one RS ID may be associated with a bitmap indicating the one or more neighboring RS resources of the corresponding RS resource of the RS resource set. As an example, for each target CSI-RS/SSB resource set within a CSI-RS/SSB resource set, a number of CSI-RS/SSB resource IDs may be signaled as associated neighboring CSI-RS/SSB resources.

At 906, the UE identifies one or more neighboring RS resources associated with at least one target RS resource based on the neighboring RS resource configuration, e.g., as described in connection with FIG. 9A. As an example, for a target CSI-RS/SSB resource, the UE may identify within a CSI-RS/SSB resource set, one or more neighboring CSI-RS/SSB resources. The identification may be performed, e.g., by the neighboring RS resource identification component 198. The identification may include any of the aspects described in connection with FIGS. 4A-8. In some aspects, the RS resource set may be associated with a set of beams. The neighboring RS resource configuration may include precoding information associated with a direction of a corresponding beam among the set of beams, and the one or more neighboring RS resources may include a subset of RS resources among the RS resource set, the subset of RS resources having smallest precoding differences from the at least one target RS resource. The direction of the corresponding beam may be based on a first direction in azimuth angles and a second direction in elevation angles. The subset of RS resources having the smallest precoding difference from the at least one target RS resource may be based on at least one of the first direction or the second direction of the beams associated with the subset of RS resources.

In some aspects, the UE may transmit information, at 912, based on the at least one target RS resource and the one or more neighboring RS resources. The transmission may be performed, e.g., by the neighboring RS resource identification component 198, the cellular baseband processor 1024, transceiver 1022, and/or antennas 1080. In some aspects, the resource set may include at least one of a CSI-RS resource set or an SSB resource set. In some aspects, the UE may report at least one channel measurement of the one or more neighboring RS resources associated with the at least one target RS resource. The neighboring RS resource configuration may be comprised in a CSI report setting or a CSI resource setting. The at least one channel measurement may include at least one of an L1-RSRP or L1-SINR.

As illustrated at 908, the UE may perform channel measurements of the RS resource set, and the at least one target RS resource may be identified, at 906, based on the channel measurements of the RS resource set. The channel measurement and identification may be performed, e.g., by the neighboring RS resource identification component 198.

In some aspects, the UE may receive an identifier of the at least one target RS resource, at 904. The reception may be performed, e.g., by the neighboring RS resource identification component 198, the cellular baseband processor 1024, transceiver 1022, and/or antennas 1080.

As illustrated, at 910, the UE may prioritize reporting of the one or more neighboring RS resources based on at least one of the at least one target RS resource or the one or more neighboring RS resources. The prioritization may be performed, e.g., by the neighboring RS resource identification component 198. In some aspects, the at least one target RS resource may include a first target RS resource and a second target RS resource and one or more neighboring RS resources may include a first neighboring RS resource set and a second neighboring RS resource set. The at least one channel measurement, e.g., at 908, may include the first neighboring RS resource set having a higher priority over the second neighboring RS resource set based on at least one of the first target RS resource having a greater channel measurement than the second target RS resource or the first neighboring RS resource set having a greater number RS resources than the second neighboring RS resource set.

In some aspects, the one or more neighboring RS resources may include a first neighboring RS resource and a second neighboring RS resource associated with a first target RS resource. The at least one channel measurement, at 908, may include the first neighboring RS resource having a higher priority over the second neighboring RS resource based on a first ID of at least one of the first neighboring RS resource in comparison to a second ID of the second neighboring RS resource.

In some aspects, e.g., at 902, the UE may receive a machine learning configuration that indicates the resource set. The reception may be performed, e.g., by the neighboring RS resource identification component 198, the cellular baseband processor 1024, transceiver 1022, and/or antennas 1080. Then, at 912, the UE may transmit an indication of a predicted channel characteristic associated with at least one beam direction based on the machine learning configuration and the resource set. In some aspects, e.g., at 902, the UE may receive a machine learning configuration that indicates the resource set. Then, at 912, the UE may transmit an indication of a predicted beam failure or a predicted beam blockage based on the machine learning configuration and the resource set, where the neighboring RS resource configuration is comprised in a BFD-RS configuration. In some aspects, the machine learning configuration may include at least one ML-model input including an identifier and a channel measurement of the at least one target RS resource or channel measurements of the one or more neighboring RS resources; and at least one ML-model output including the predicted beam failure or the predicted beam blockage in one or more of a time domain or a frequency domain.

In some aspects, to receive the neighboring RS resource configuration at 902, the UE may receive a set of neighboring RS resource configurations and receive an indication to activate one neighboring RS resource configuration among the set of neighboring RS resource configurations.

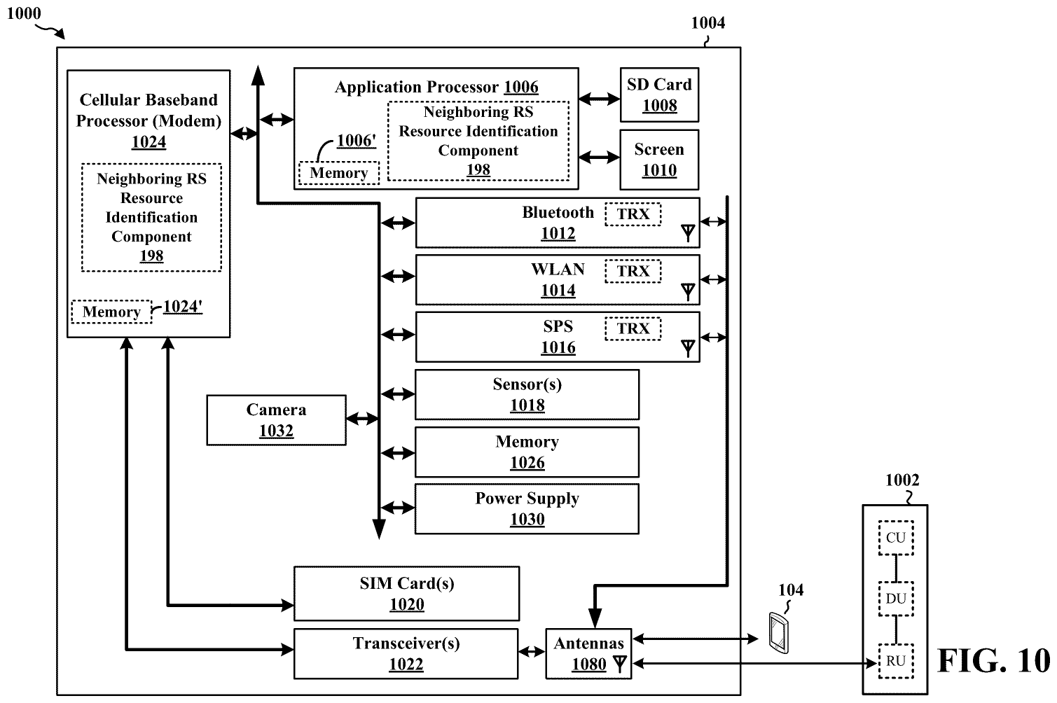

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed supra, the neighboring RS resource identification component 198 is configured to receive a neighboring RS resource configuration associated with an RS resource set and identify one or more neighboring RS resources associated with at least one target RS resource based on the neighboring RS resource configuration, e.g., as described in connection with FIG. 9A and/or 9B. The neighboring RS resource identification component 198 may be further configured to transmit information, at 912, based on the at least one target RS resource and the one or more neighboring RS resources; perform channel measurements of the RS resource set, and the at least one target RS resource may be identified based on the channel measurements of the RS resource set; receive an identifier of the at least one target RS resource; prioritize reporting of the one or more neighboring RS resources based on at least one of the at least one target RS resource or the one or more neighboring RS resources; receive a machine learning configuration that indicates the resource set; transmit an indication of a predicted channel characteristic associated with at least one beam direction based on the machine learning configuration and the resource set; receive a machine learning configuration that indicates the resource set; transmit an indication of a predicted beam failure or a predicted beam blockage based on the machine learning configuration and the resource set, where the neighboring RS resource configuration is comprised in a BFD-RS configuration; or receive a set of neighboring RS resource configurations and receive an indication to activate one neighboring RS resource configuration among the set of neighboring RS resource configurations, e.g., as described in connection with any of the aspects of FIG. 9A and/or 9B. The neighboring RS resource identification component 198 and/or another component that may be included in the cellular baseband processor 1024 and/or the application processor 1006 may be configured to perform any of the aspects performed by the UE in FIG. 8. The neighboring RS resource identification component 198 may be within the cellular baseband processor 1024, the application processor 1006, or both the cellular baseband processor 1024 and the application processor 1006. The neighboring RS resource identification component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for receiving a neighboring RS resource configuration associated with an RS resource set and means for identifying one or more neighboring RS resources associated with at least one target RS resource based on the neighboring RS resource configuration, e.g., as described in connection with FIG. 9A and/or 9B. The apparatus may further include means for transmitting information based on the at least one target RS resource and the one or more neighboring RS resources; means for performing channel measurements of the RS resource set, and the at least one target RS resource may be identified based on the channel measurements of the RS resource set; receive an identifier of the at least one target RS resource; means for prioritizing reporting of the one or more neighboring RS resources based on at least one of the at least one target RS resource or the one or more neighboring RS resources; means for receiving a machine learning configuration that indicates the resource set; means for transmitting an indication of a predicted channel characteristic associated with at least one beam direction based on the machine learning configuration and the resource set; means for receiving a machine learning configuration that indicates the resource set; means for transmitting an indication of a predicted beam failure or a predicted beam blockage based on the machine learning configuration and the resource set, where the neighboring RS resource configuration is comprised in a BFD-RS configuration; or means for receiving a set of neighboring RS resource configurations and means for receiving an indication to activate one neighboring RS resource configuration among the set of neighboring RS resource configurations. The means may be the neighboring RS resource identification component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

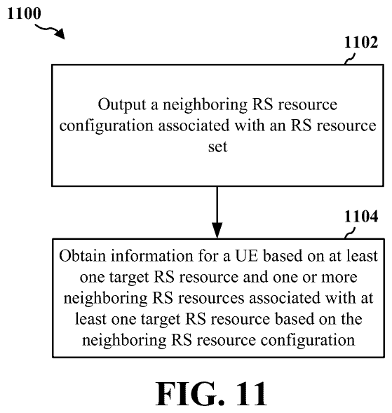

FIG. 11 is a flowchart 1100 of a method of wireless communication. The method may be performed by a network node or a network entity, which may include a base station and/or a component of a base station (e.g., the base station 102, 310; network node 804; the CU 110; the DU 130; the RU 140; the network entity 1202). The method may improve beam management through enabling the UE to report not just measurements of a strongest beam, but also enabling the UE to identify one or more neighboring beams associated with a target beam as a part of beam management. The method may include any of the aspects described in connection with the UE in FIG. 8.

At 1102, the network entity outputs a neighboring RS resource configuration associated with an RS resource set. As an example, a network node may transmit a neighboring RS resource configuration associated with an RS resource set. The output may be performed, e.g., by the neighboring RS resource configuring component 199. In some aspects, to output the neighboring RS resource configuration, the network entity may output a set of neighboring RS resource configurations and output an indication to activate one neighboring RS resource configuration among the set of neighboring RS resource configurations.

At 1104, the network entity obtains information for a UE based on at least one target RS resource and one or more neighboring RS resources associated with at least one target RS resource based on the neighboring RS resource configuration. In some aspects, a network node may receive the information from the UE. The obtaining may be performed, e.g., by the neighboring RS resource configuring component 199.

The neighboring RS resource configuration may include one or more bitmaps, each bitmap indicating the one or more neighboring RS resources of a corresponding RS resource of the RS resource set. The neighboring RS resource configuration may include at least one RS ID, each of the at least one RS ID indicating the one or more neighboring RS resources of the corresponding RS resource of the RS resource set.

In some aspects, at 1102, the network entity may output a machine learning configuration that indicates the resource set; and, at 1104, the network entity may obtain an indication of a predicted channel characteristic associated with at least one beam direction based on the machine learning configuration and the resource set. In some aspects, at 1102, the network entity may output a machine learning configuration that indicates the resource set; and, at 1104, the network entity may obtain an indication of a predicted beam failure or a predicted beam blockage based on the machine learning configuration and the resource set, where the neighboring RS resource configuration is comprised in a BFD-RS configuration.

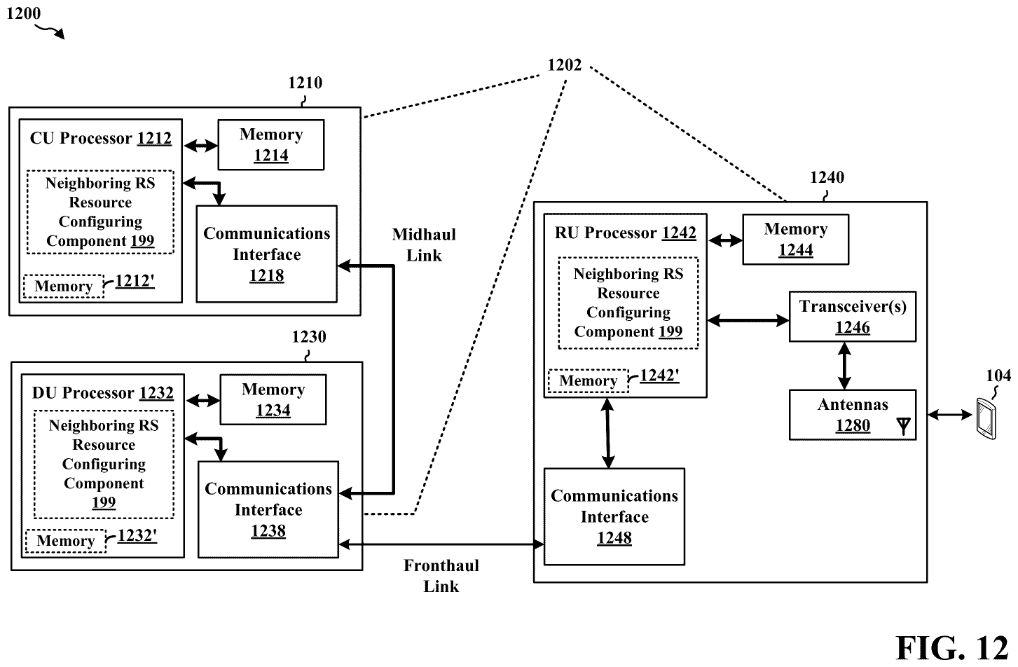

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the neighboring RS resource configuring component 199 is configured to output a neighboring RS resource configuration associated with an RS resource set and obtain information for a UE based on at least one target RS resource and one or more neighboring RS resources associated with at least one target RS resource based on the neighboring RS resource configuration, e.g., as described in connection with FIG. 11. The neighboring RS resource configuring component 199 may be within one or more processors of one or more of the CU 1210, DU 1230, and the RU 1240. The neighboring RS resource configuring component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for means for outputting a neighboring RS resource configuration associated with an RS resource set; and means for obtaining information for a UE based on at least one target RS resource and one or more neighboring RS resources associated with at least one target RS resource based on the neighboring RS resource configuration. The means may be the neighboring RS resource configuring component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means. The network entity may include a component, such as the neighboring RS resource configuring component 199 or another component, that is configured to perform any of the aspects described in connection with FIG. 11 and/or the aspects performed by the network entity in FIG. 8.

The method of wireless communication may improve beam management through enabling the UE to report not just measurements of a strongest beam, but also enabling the UE to identify one or more neighboring beams associated with a target beam as a part of beam management, without increasing the signaling overhead to indicate the neighboring beams. The UE may receive a neighboring RS resource configuration associated with an RS resource set and identify one or more neighboring RS resources associated with at least one target RS resource based on the neighboring RS resource configuration. The network node may output a neighboring RS resource configuration associated with an RS resource set, and obtain information for a UE based on at least one target RS resource and one or more neighboring RS resources associated with at least one target RS resource based on the neighboring RS resource configuration.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising receiving a neighboring RS resource configuration associated with an RS resource set; and identifying one or more neighboring RS resources associated with at least one target RS resource based on the neighboring RS resource configuration.

In aspect 2, the method of aspect 1 further includes transmitting information based on the at least one target RS resource and the one or more neighboring RS resources.

In aspect 3, the method of aspect 1 or aspect 2 further includes that the neighboring RS resource configuration includes at least one bitmap, each bitmap indicating the one or more neighboring RS resources of a corresponding RS resource of the RS resource set.

In aspect 4, the method of aspect 3 further includes that each bitmap includes a plurality of bits, each bit of the plurality of bits indicating whether each RS resource of the RS resource set is included in the one or more neighboring RS resources.

In aspect 5, the method of aspect 4 further includes that the plurality of bits includes N−1 bits, wherein N refers to a total number of RS resources in the RS resource set.

In aspect 6, the method of aspect 4 further includes that each bitmap indicates a subset of the RS resource set that is included in the one or more neighboring RS resources.

In aspect 7, the method of aspect 3 further includes that each bitmap includes a plurality of bits, each bit of the plurality of bits indicating whether each RS resource of the subset of the RS resource set is included in the one or more neighboring RS resources.

In aspect 8, the method of aspect 1 or aspect 2 further includes that the neighboring RS resource configuration includes at least one RS ID, each of the at least one RS ID indicating the one or more neighboring RS resources of a corresponding RS resource of the RS resource set.

In aspect 9, the method of aspect 8 further includes that each of the at least one RS ID is associated with a bitmap indicating the one or more neighboring RS resources of the corresponding RS resource of the RS resource set.

In aspect 10, the method of any of aspects 1-9 further includes that the RS resource set is associated with a set of beams, the neighboring RS resource configuration includes precoding information associated with a direction of a corresponding beam among the set of beams, and the one or more neighboring RS resources includes a subset of RS resources among the RS resource set, the subset of RS resources having smallest precoding differences from the at least one target RS resource.

In aspect 11, the method of aspect 10 further includes that the direction of the corresponding beam is based on a first direction in azimuth angles and a second direction in elevation angles, and the subset of RS resources having the smallest precoding difference from the at least one target RS resource based on at least one of the first direction or the second direction of the beams associated with the subset of RS resources.

In aspect 12, the method of any of aspects 1-11 further includes receiving the neighboring RS resource configuration, wherein the resource set comprises at least one of a CSI-RS resource set or an SSB resource set.

In aspect 13, the method of aspect 12 further includes reporting at least one channel measurement of the one or more neighboring RS resources associated with the at least one target RS resource, wherein the neighboring RS resource configuration is comprised in a CSI report setting or a CSI resource setting.

In aspect 14, the method of aspect 13 further includes that the at least one channel measurement includes at least one of a L1-RSRP or an L1-SINR.

In aspect 15, the method of aspect 13 or 14 further includes performing channel measurements of the RS resource set, and the at least one target RS resource is identified based on the channel measurements of the RS resource set.

In aspect 16, the method of any of aspect 13 or 14 further includes receiving an identifier of the at least one target RS resource.

In aspect 17, the method of any of aspects 13-16 further includes prioritizing reporting of the one or more neighboring RS resources based on at least one of the at least one target RS resource or the one or more neighboring RS resources.

In aspect 18, the method of aspect 17 further includes that the at least one target RS resource includes a first target RS resource and a second target RS resource and one or more neighboring RS resources include a first neighboring RS resource set and a second neighboring RS resource set, and wherein the at least one channel measurement includes the first neighboring RS resource set having a higher priority over the second neighboring RS resource set based on at least one of the first target RS resource having a greater channel measurement than the second target RS resource or the first neighboring RS resource set having a greater number RS resources than the second neighboring RS resource set.

In aspect 19, the method of aspect 17 further includes that the one or more neighboring RS resources include a first neighboring RS resource and a second neighboring RS resource associated with a first target RS resource, wherein the at least one channel measurement includes the first neighboring RS resource having a higher priority over the second neighboring RS resource based on a first identifier (ID) of at least one of the first neighboring RS resource in comparison to a second ID of the second neighboring RS resource.

In aspect 20, the method of any of aspects 1-19 further includes receiving a machine learning configuration that indicates the resource set; and transmitting an indication of a predicted channel characteristic associated with at least one beam direction based on the machine learning configuration and the resource set.

In aspect 21, the method of any of aspects 1-19 further includes receiving a machine learning configuration that indicates the resource set; and transmitting an indication of a predicted beam failure or a predicted beam blockage based on the machine learning configuration and the resource set, wherein the neighboring RS resource configuration is comprised in a BFD-RS configuration.

In aspect 22, the method of aspect 21 further includes that the machine learning configuration includes: at least one ML-model input including an identifier and a channel measurement of the at least one target RS resource or channel measurements of the one or more neighboring RS resources; and at least one ML-model output including the predicted beam failure or the predicted beam blockage in one or more of a time domain or a frequency domain.

In aspect 23, the method of any of aspects 1-22 further includes that receiving the neighboring RS resource configuration includes receiving a set of neighboring RS resource configurations; and receiving an indication to activate one neighboring RS resource configuration among the set of neighboring RS resource configurations.

Aspect 24 is an apparatus for wireless communication at a UE comprising means for performing the method of any of aspects 1-23.

Aspect 25 is an apparatus for wireless communication at a UE comprising memory and at least one processor coupled to the memory and configured to perform the method of any of aspects 1-23.

In aspect 26, the apparatus of aspect 25 further includes at least one of a transceiver or an antenna.

Aspect 27 is a non-transitory computer-readable medium storing computer executable code at a UE, the code when executed by a processor causes the processor to perform the method of any of aspects 1-23.

Aspect 28 is a method of wireless communication at a network entity, comprising outputting a neighboring RS resource configuration associated with an RS resource set; and obtaining information for a UE based on at least one target RS resource and one or more neighboring RS resources associated with at least one target RS resource based on the neighboring RS resource configuration.

In aspect 29, the method of aspect 28 further includes that the neighboring RS resource configuration includes at least one of: one or more bitmaps, each bitmap indicating the one or more neighboring RS resources of a corresponding RS resource of the RS resource set, or at least one RS ID, each of the at least one RS ID indicating the one or more neighboring RS resources of the corresponding RS resource of the RS resource set.

In aspect 30, the method of aspect 28 or aspect 29 further includes outputting a machine learning configuration that indicates the resource set; and obtaining an indication of a predicted channel characteristic associated with at least one beam direction based on the machine learning configuration and the resource set.

In aspect 31, the method of aspect 28 or aspect 29 further includes outputting a machine learning configuration that indicates the resource set; and obtaining an indication of a predicted beam failure or a predicted beam blockage based on the machine learning configuration and the resource set, wherein the neighboring RS resource configuration is comprised in a BFD-RS configuration.

In aspect 32, the method of any of aspects 28-31 includes that outputting the neighboring RS resource configuration includes outputting a set of neighboring RS resource configurations; and outputting an indication to activate one neighboring RS resource configuration among the set of neighboring RS resource configurations.

Aspect 33 is an apparatus for wireless communication at a network entity comprising means for performing the method of any of aspects 28-32.

Aspect 34 is an apparatus for wireless communication at a network entity comprising memory and at least one processor coupled to the memory and configured to perform the method of any of aspects 28-32.

In aspect 35, the apparatus of aspect 34 further includes at least one of a transceiver or an antenna.

Aspect 36 is a non-transitory computer-readable medium storing computer executable code at a network entity, the code when executed by a processor causes the processor to perform the method of any of aspects 28-32.

What is claimed is:

1. An apparatus for wireless communication at a user equipment (UE), comprising:
a memory; and
at least one processor coupled to the memory and configured to:
receive a neighboring reference signal (RS) resource configuration associated with an RS resource set; and
identify one or more neighboring RS resources associated with at least one target RS resource based on the neighboring RS resource configuration.

2. The apparatus of claim 1, wherein the at least one processor is further configured to transmit information based on the at least one target RS resource and the one or more neighboring RS resources.

3. The apparatus of claim 1, wherein the neighboring RS resource configuration includes at least one bitmap, each bitmap indicating the one or more neighboring RS resources of a corresponding RS resource of the RS resource set.

4. The apparatus of claim 3, wherein each bitmap includes a plurality of bits, each bit of the plurality of bits indicating whether each RS resource of the RS resource set is included in the one or more neighboring RS resources.

5. The apparatus of claim 4, wherein the plurality of bits includes N−1 bits, wherein N refers to a total number of RS resources in the RS resource set.

6. The apparatus of claim 4, wherein each bitmap indicates a subset of the RS resource set that is included in the one or more neighboring RS resources.

7. The apparatus of claim 3, wherein each bitmap includes a plurality of bits, each bit of the plurality of bits indicating whether each RS resource of a subset of the RS resource set is included in the one or more neighboring RS resources.

8. The apparatus of claim 1, wherein the neighboring RS resource configuration includes at least one RS identifier (ID), each of the at least one RS ID indicating the one or more neighboring RS resources of a corresponding RS resource of the RS resource set.

9. The apparatus of claim 8, wherein each of the at least one RS ID is associated with a bitmap indicating the one or more neighboring RS resources of the corresponding RS resource of the RS resource set.

10. The apparatus of claim 1, wherein the RS resource set is associated with a set of beams,
the neighboring RS resource configuration includes precoding information associated with a direction of a corresponding beam among the set of beams, and
the one or more neighboring RS resources includes a subset of RS resources among the RS resource set, the subset of RS resources having smallest precoding differences from the at least one target RS resource.

11. The apparatus of claim 10, wherein the direction of the corresponding beam is based on a first direction in azimuth angles and a second direction in elevation angles, and
the subset of RS resources has the smallest precoding difference from the at least one target RS resource based on at least one of the first direction or the second direction of the beams associated with the subset of RS resources.

12. The apparatus of claim 1, further comprising:
at least one transceiver configured to receive the neighboring RS resource configuration, wherein the resource set comprises at least one of a channel state information reference signal (CSI-RS) resource set or a synchronization signal block (SSB) resource set.

13. The apparatus of claim 12, wherein the at least one processor is further configured to:
report at least one channel measurement of the one or more neighboring RS resources associated with the at least one target RS resource,
wherein the neighboring RS resource configuration is comprised in a channel status information (CSI) report setting or a CSI resource setting.

14. The apparatus of claim 13, the at least one channel measurement includes at least one of a physical layer (L1) reference signal received power (RSRP) (L1-RSRP) or an L1 signal to interference plus noise ratio (SINR) (L1-SINR).

15. The apparatus of claim 13, wherein the at least one processor is further configured to perform channel measurements of the RS resource set, and
the at least one target RS resource is identified based on the channel measurements of the RS resource set.

16. The apparatus of claim 13, wherein the at least one processor is further configured to receive an identifier of the at least one target RS resource.

17. The apparatus of claim 13, wherein the at least one processor is further configured to prioritize reporting of the one or more neighboring RS resources based on at least one of the at least one target RS resource or the one or more neighboring RS resources.

18. The apparatus of claim 17, wherein the at least one target RS resource includes a first target RS resource and a second target RS resource and the one or more neighboring RS resources include a first neighboring RS resource set and a second neighboring RS resource set,
wherein the at least one channel measurement includes the first neighboring RS resource set having a higher priority over the second neighboring RS resource set based on at least one of the first target RS resource having a greater channel measurement than the second target RS resource or the first neighboring RS resource set having a greater number RS resources than the second neighboring RS resource set.

19. The apparatus of claim 17, wherein the one or more neighboring RS resources include a first neighboring RS resource and a second neighboring RS resource associated with a first target RS resource,
wherein the at least one channel measurement includes the first neighboring RS resource having a higher priority over the second neighboring RS resource based on a first identifier (ID) of at least one of the first neighboring RS resource in comparison to a second ID of the second neighboring RS resource.

20. The apparatus of claim 1, wherein the at least one processor is further configured to:
receive a machine learning configuration that indicates the resource set; and
transmit an indication of a predicted channel characteristic associated with at least one beam direction based on the machine learning configuration and the resource set.

21. The apparatus of claim 1, wherein the at least one processor is further configured to:
receive a machine learning configuration that indicates the resource set; and
transmit an indication of a predicted beam failure or a predicted beam blockage based on the machine learning configuration and the resource set,
wherein the neighboring RS resource configuration is comprised in a beam failure detection (BFD) RS (BFD-RS) configuration.

22. The apparatus of claim 21, wherein the machine learning configuration includes:
at least one ML-model input including an identifier and a channel measurement of the at least one target RS resource or channel measurements of the one or more neighboring RS resources; and
at least one ML-model output including the predicted beam failure or the predicted beam blockage in one or more of a time domain or a frequency domain.

23. The apparatus of claim 1, wherein, to receive the neighboring RS resource configuration, the at least one processor is further configured to:
receive a set of neighboring RS resource configurations; and
receive an indication to activate one neighboring RS resource configuration among the set of neighboring RS resource configurations.

24. A method of wireless communication at a user equipment (UE), comprising:
receiving a neighboring reference signal (RS) resource configuration associated with an RS resource set;
identifying one or more neighboring RS resources associated with at least one target RS resource based on the neighboring RS resource configuration; and
transmitting information based on the at least one target RS resource and the one or more neighboring RS resources.

25. An apparatus for wireless communication at a network entity, comprising:
a memory; and
at least one processor coupled to the memory and configured to:
output a neighboring reference signal (RS) resource configuration associated with an RS resource set; and
obtain information for a user equipment (UE) based on at least one target resource RS and one or more neighboring RS resources associated with at least one target RS resource based on the neighboring RS resource configuration.

26. The apparatus of claim 25, wherein the neighboring RS resource configuration includes at least one of:
one or more bitmaps, each bitmap indicating the one or more neighboring RS resources of a corresponding RS resource of the RS resource set, or
at least one RS identifier (ID), each of the at least one RS ID indicating the one or more neighboring RS resources of the corresponding RS resource of the RS resource set.

27. The apparatus of claim 25, wherein the at least one processor is further configured to:
output a machine learning configuration that indicates the resource set; and
obtain an indication of a predicted channel characteristic associated with at least one beam direction based on the machine learning configuration and the resource set.

28. The apparatus of claim 25, wherein the at least one processor is further configured to:
output a machine learning configuration that indicates the resource set; and
obtain an indication of a predicted beam failure or a predicted beam blockage based on the machine learning configuration and the resource set,
wherein the neighboring RS resource configuration is comprised in a beam failure detection (BFD) RS (BFD-RS) configuration.

29. The apparatus of claim 25, wherein, to receive the neighboring RS resource configuration, the at least one processor is further configured to:
output a set of neighboring RS resource configurations; and
output an indication to activate one neighboring RS resource configuration among the set of neighboring RS resource configurations.

30. A method of wireless communication at a network entity, comprising:
outputting a neighboring reference signal (RS) resource configuration associated with an RS resource set; and
obtaining information for a user equipment (UE) based on at least one target resource RS and one or more neighboring RS resources associated with at least one target RS resource based on the neighboring RS resource configuration.
